(19) United States
(12) Patent Application Publication
(10) Pub. No.: US 2015/0227463 A1
(43) Pub. Date: Aug. 13, 2015

(54) PRECACHING OF RESPONSIVE INFORMATION

(71) Applicant: Cisco Technology, Inc., San Jose, CA (US)

(72) Inventors: Charles Calvin Byers, Wheaton, IL (US); Monique Jeanne Morrow, Zurich (CH); Russell Paul Gyurek, Raleigh, NC (US); Michael De Leo, Sunrise, FL (US)

(73) Assignee: Cisco Technology, Inc., San Jose, CA (US)

(21) Appl. No.: 14/176,031

(22) Filed: Feb. 7, 2014

(51) Int. Cl. G06F 12/08

(52) U.S. Cl. CPC G06F 12/0862; G06F 2212/602

(57) ABSTRACT

A precaching system receives a communication regarding a subject. Based on the content of the communication, the precaching system determines the identity of the subject, as well as an indication of information that may be responsive to the communication. The precaching system also identifies a recipient of the information. Based on the indication of responsive information, the precaching system identifies responsive information that is associated with an archival-type storage system. The precaching system then determines a non-archival location to precache the responsive information so that the identified recipient can more quickly and/or more reliably access the responsive information (as compared to accessing the information from the archival storage). For example, the precaching system identifies an edge device near the recipient as the precaching location. The precaching system then precaches the responsive information at the determined precaching location. The recipient can then access the information from the precaching location.

### TECHNICAL FIELD

The present disclosure relates generally to precaching of responsive information, and more particularly to methods and systems for decreasing the latency associated with retrieving responsive information from archival storage and providing the responsive information to a recipient.

### BACKGROUND

As the ability to create and store large volumes of electronic information has expanded, so too has the need for subjects to quickly and reliably access the stored electronic information. A prime example of this phenomenon is the storage and accessibility of electronic health records. Every individual in a healthcare system, for example, can have hundreds or even thousands of data objects permanently stored in a database over their lifetime. These objects, which are collectively referred to as electronic health records, range from short text notes (a few sentences in length) to lab reports that are kilobytes to megabytes in size or greater. For example, a compressed human DNA sequence may be roughly 1 gigabyte in size, whereas high resolution, full motion, three-dimensional studies from computed tomography (CT) scans, magnetic resonance imaging (MRI), or positron emission tomography (PET) scanners can be terabytes in size.

Although offline archival storage systems may be used to store large volumes of information, such storage systems have substantial performance disadvantages. For example, mechanical storage devices need to locate the media (tape cartridge, optical disk, or other device) holding the responsive information, and then physically move it to a shared drive so it can be mounted and accessed on a cloud-based network. This process alone may take several seconds to a few minutes (and even longer if the storage array is busy and not enough drives exist to serve all requests for the storage media they contain). Busy medical professionals, for example, prefer not to wait for this latency to retrieve the electronic health records, especially during a life-threatening emergency where time is of the essence. A delay of a few minutes when retrieving an electronic health record containing critical information (a drug allergy or heart condition, for example), can result in serious consequences, and even fatalities.

### BRIEF DESCRIPTION OF THE DRAWINGS

FIG. 1 is a block diagram depicting a system for precaching responsive information, in accordance with certain example embodiments.

FIG. 2 is a block flow diagram depicting a method for retrieving and precaching responsive information for an identified recipient, in accordance with certain example embodiments.

FIG. 3 is a block flow diagram depicting a method for determining information responsive to a communication from a communication system 130, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

A method comprises receiving a communication regarding a subject, wherein the communication comprises content indicating information that is responsive to the communication. The content of the communication is determined, and—based on the content of the communication—information that is responsive to the communication is identified in an archival storage system. A recipient of the responsive information is also identified based on the content of the communication. A location for precaching the responsive information is then determined, wherein the location is associated with a non-archival storage system such as a cloud-based or fog-based system. In response to determining a location for precaching the information, the responsive information is precached at the determined precaching location. By precaching the information at the determined precaching location, the latency associated with the recipient receiving the information is decreased. Precaching the information at the determined precaching location may also decrease the load on the network and improve the security and reliability associated with accessing the information.

### DESCRIPTION

Because of the need to quickly and reliably access information such as electronic health records, the electronic health records for an entire population could be stored in a large, high-performance cloud-based storage system. The electronic health records could then be accessed at any time for retrieval by any healthcare professional within a few seconds. Unfortunately, the high cost of such a high performance online storage is prohibitive, especially when used to store large volumes of data. Hence, archival storage systems—such as offline, robot tape archives, optical jukeboxes, or other mechanical storage devices—are often used to store electronic health records as a far less expensive alternative to cloud-based storage.

As disclosed herein, a precaching system determines and retrieves responsive information for a recipient, such as from an archival storage system, in anticipation of a need for the responsive information. For example, the precaching system receives a communication regarding a subject. Based on the content of the communication, the precaching system determines the identity of the subject, as well as an indication of information that may be responsive to the communication. The precaching system also identifies a recipient of the information. In certain examples, the precaching system may also identify the recipient's physical or logical network location. Based on the indication of responsive information, the precaching system identifies specific information, such as from an archival-type storage system, that is responsive to the communication. The precaching system then determines a location to precache the responsive information so that the recipient of the information can more quickly and reliably access the responsive information (as compared to accessing the information from the archival storage). The precaching system then precaches the responsive information at the determined location, such as by copying the information from the long-term (archival) storage location to a higher performance, more local precache.

More particularly, a system, such as the precaching system, stores information for several subjects in archival storage for multiple subjects, along with a record for each subject. For example, as the precaching system receives information for a particular subject, the precaching system records the information in a large-scale storage archive, along with information identifying the information as relating to the subject. A variety of storage devices or units may be used to store the information, including off-line or near-line technologies, such as high-capacity robot tape archives, optical jukebox archives, or other conventional, archival storage systems. The stored information can be any type of information that relates to one or more subjects. For example, the information may comprise electronic health records of various subjects, maintenance records for items belonging to various subject (such as automobile maintenance records), or any other type of subject information or records that is typically stored in off-line or near-line storage. In certain examples, portions of responsive information may additionally or alternatively be stored in faster storage systems. For example, electronic health records for a recent medical examination of the subject may reside on a cloud-based storage unit before such records are archived.

After the information for several subjects is stored, the precaching system receives a communication regarding a particular subject. The communication can be any communication related to the particular subject. For example, the precaching system may receive a communication regarding a medical emergency of the subject, such as a communication from an emergency dispatch system. Or, in another example, the precaching system may receive a communication from an appointment scheduling system, which notifies the precaching system of a service appointment for the subject's automobile.

Based on the content of the received communication, the precaching system determines the identity of the particular subject, as well as the type of information that may be responsive to the communication. The precaching system also determines one or more recipients of the information. For example, after reading the content of the communication, the precaching may determine that a particular communication relates to a medical emergency of the subject. Hence, based on the content of such a communication, the precaching system may determine that the subject's electronic health records are responsive to the communication and that the medical professionals at local hospitals are the recipients of the subject's health records. In another example, the precaching system may receive a communication relating to a scheduled service appointment for the subject's automobile. The precaching system may thus determine that the automobile's maintenance history records are responsive to the communication and that mechanics at the service center—where the appointment is scheduled—are the recipients of the information.

Once the precaching system determines the type of information that is responsive to the communication, the precaching system locates a record for the particular subject in the archival storage. For example, the precaching system compares the identified subject information with the subject records in the archival storage. If the precaching system identifies a match for the subject in the archival storage, the precaching system reads the subject's stored information for responsive information. For example, the precaching system may identify the electronic health records of the subject (for a medical emergency of the subject). Or, for a scheduled service of the subject's automobile, the precaching system may identify the maintenance history records for the subject's automobile. In certain examples, such as when recent records of the subject are temporality stored in a cloud-based storage, the precaching system may also identify responsive information from the cloud-based storage.

After identifying information responsive to the communication, the precaching system determines a location to precache the retrieved information. That is, the precaching system determines a location within a non-archival network to precache the retrieved information so that recipients of the information can more quickly and reliably access the information (as compared to accessing the information directly from an archival storage system). For example, if the precaching system has retrieved a particular subject's electronic health records from archival storage, the precaching system may determine a geographic location within a cloud-based network to precache the electronic health records near the recipients' physical or logical network location.

In certain examples, the location may be any location within a cloud-based network, as precaching the otherwise archived information within the cloud-based, non-archival storage will increase the speed at which the recipients can access the information. In certain examples, the precaching system may determine a precaching location that is geographically close to recipient in the cloud-based network, thus further decreasing the latency associated with accessing the information. For example, if the precaching system has identified medical professionals at a local hospital as the recipients of the subject's electronic health records—such as in response to a communication indicating a medical emergency for the subject—the precaching system may determine a location at or near the hospital for precaching the subject's electronic health records. The precaching system may also select locations that are logically near the recipients, such as locations that have network accessibility that minimizes latency and resource use. In certain examples, the logically near locations may be geographically far removed from the recipients, but in network terms are a small in the number of network hops away. The locations may also rely on network hops that use high-speed connections, are lightly loaded, and/or that originate from reliable transmission facilities.

Additionally or alternatively, the precaching system may determine the precaching location based on reliability of the network, such as when a particular geographic location within the could-based network is associated with a more reliable network than a different location within the network. Additionally or alternatively, the precaching system may determine a precaching location that is more secure than another location. For example, when precaching health records of a subject, the precaching system may determine a location that is associated with a private network, such as a virtual private network, of the recipients.

Once the precaching system determines a location for precaching the responsive information, the precaching system precaches the information at the determined location. For example, the precaching system may—after identifying a subject's electronic health records—precache the health records on an accessible and secure server located at a nearby hospital, thus allowing the medical professionals ready access to the particular subject's electronic health records. Or, if the precaching system identifies maintenance history records for the subject's automobile, the precaching system may precache the maintenance records on a network device near the service center, such as on an edge storage device having storage capabilities near the service center. The recipients—such as the medical staff or the mechanics in the above examples—can then access the relevant records of the subject from the edge-based storage, for example.

By identifying responsive information from archival-type storage and then precaching the responsive information in a non-archival storage, the methods and systems described herein decrease the latency associated with retrieving responsive information. That is, rather than having to wait for responsive information to be retrieved from archival storage, the methods and systems described herein allow the recipients to quickly access the information from a readily accessible storage source. And, in certain examples, the methods and systems described herein provide the recipient with a more reliable and/or more secure access to responsive information.

### Example System Architectures

Turning now to the drawings, in which like numerals indicate like (but not necessarily identical) elements throughout the figures, example embodiments are described in detail.

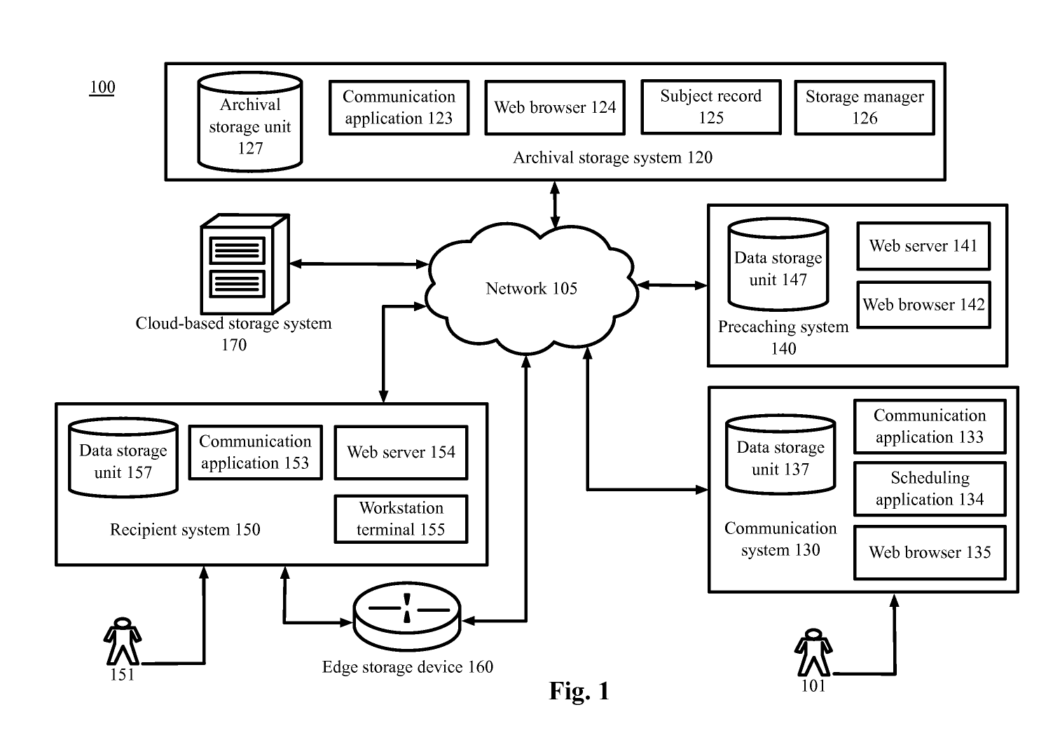

FIG. 1 is a block diagram depicting a system for precaching responsive information, in accordance with certain example embodiments.

As depicted in FIG. 1, the example operating environment 100 includes an archival storage computing system 120, a communication computing system 130, a precaching computing system 140, a recipient computing system 150, an edge storage computing device 160, and a cloud-based storage computing unit 170 that communicate with each other via one or more networks 105. In certain example embodiments, two or more of these systems (including systems 120, 130, 140, 150, 160, and 170) or parts thereof may be integrated into the same system. In certain example embodiments, a subject 101 registers with the communication system 130 and/or the precaching system 140 to obtain the benefits of the methods and techniques described herein.

Each network 105 includes a wired or wireless telecommunication means by which network computing devices (including devices 120, 130, 140, 150, 160, and 170) can exchange data. For example, each network 105 can include a local area network (“LAN”), a wide area network (“WAN”), an intranet, an Internet, a storage area network (SAN), a personal area network (PAN), a metropolitan area network (MAN), a wireless local area network (WLAN), a virtual private network (VPN), a cellular or other mobile communication network, Bluetooth, near field communication (NFC), optical networks, or any combination thereof or any other appropriate architecture or system that facilitates the communication of signals, data, and/or messages or objects. Throughout the discussion of example embodiments, it should be understood that the terms “data” and “information” are used interchangeably herein to refer to text, images, audio, video, or any other form of information that can exist in a computer-based environment.

Each network computing device 120, 130, 140, 150, 160, and 170 includes a communication module capable of transmitting and receiving data over the network 105. For example, each network device 120, 130, 140, 150, 160, and 170 can include additional system components, such as a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 120, 130, 140, 150, 160, and 170 are operated by users/end-subjects or precaching system operators.

The archival storage system 120 represents a high-capacity storage system that receives and stores information. For example, the archival storage may include off-line or near-line, non-cloud-based technologies such as high-capacity robot tape archives, optical jukebox archives, microfilm, or other archival storage devices that operate to receive and store information. The archival storage system 120 includes a communication application 123, such as a web browser application 114 or a stand-alone application. The communication application 123, for example, allows the archival storage system 120 to communicate with the precaching system 140 or other devices or systems connected to the distributed network. For example, the communication application 123 may allow operators (not shown) of the archival storage system 120 or recipients 151 of information associated with the archival storage system 120 to associate information with archival storage system 120 and then later retrieve the associated information. The archival storage system 120 may also include a web browser 124, which provides a user interface that allows system operators or recipients 151 to view, download, upload, or otherwise associate information with the archival storage system 120 and then later retrieve the information via the distributed network 105. In certain example embodiments, the archival storage system 120 may include a storage manager 126 that is responsible for overall control of archival storage unit 127, including managing its space allocation, security, and redundancy.

In certain example embodiments, the archival storage system 120 may include a subject record 125. The subject record 125, for example, may associate identifying credentials of each subject 101, such as the subject's name, telephone number, residence address, email address, and/or other information, with the information in the subject record that is specific for the subject 101. For example, if the archival storage system 120 stores electronic health records for multiple subjects 101, the subject record 125 associates a particular subject 101 with the electronic health records for that particular subject 101. For example, the archival storage system 120 may associate a particular subject 101 with the subject record 125 based on the subject's unique identifier keys, such as the subject's social security number, date of birth, vehicle identification number for the subject's vehicle. Thus, the archival storage system 120 may use the subject record 125 to retrieve subject-specific information associated with the archival storage system 120, such as when the archival storage system 120 receives a request for subject-specific information as from the precaching system 140 as described herein.

The archival storage system 120 may further include a data storage unit 127. The example data storage unit 127 can include one or more tangible computer-readable storage devices. The data storage unit 127 can be a component of the archival storage system 120 or be logically coupled to the archival storage system 120. For example, the data storage unit 127 may be a high density, low cost archival device such as an optical disk. In certain example embodiments, the data storage unit 117 may store information, such as digitized documents, photographs, video files, audio files, or other digital files and information. In certain example embodiments, the storage of information may occur on cloud-based storage units 170, such as before the information is transferred to the archival storage system 120. The cloud-based storage system 170 may include, for example, a cloud storage device, a server, a storage area network (“SAN”), a network attached storage (“NAS”) that is connected to and accessible by other systems, such as the precaching system 140, associated with the distributed network 105.

The communication system 130 represents a system that process communications regarding one or more subjects 101. That is, the communication system 130 may receive and/or determine an event related to a subject 101, and then process the event by communicating information to the precaching system 140 regarding the event. For example, the communication system 130 may include a 911 emergency dispatch system that receives a medical emergency call regarding a particular subject 101 and then communicates the call information to the precaching system 140. In certain example embodiments, the communication system 130 includes a communication application 133 that allows the communication system 130 to communicate with other devices and systems connected to the network 105, such as the precaching system 140 or the recipient system 150. The communication application 133 also allows the communication system 130, for example, to communicate with the subject 101, such as with a device (not shown) of the subject 101.

In certain example embodiments, the communication system 130 may include a scheduling application 134. The scheduling application 134, for example, may interact with the communication application 134 and/or the web browser 135 to monitor and/or receive appointments regarding a subject 101. For example, if a subject 101 schedules an appointment with a recipient system 150, such as a scheduling system associated with a physician's office, the scheduling application 134 may receive information regarding the scheduled appointment and transmit then information to the precaching system 140 as described herein. The communication system 130 may also include a web browser 130, which allows subjects—such as recipients—to view, download, upload, or otherwise access the communication system 130. For example, the web browser 130 may provide a user interface for a recipient 151 to communicate appointment information for a particular subject 101 to the communication system 130.

The communication system 130 may further include a data storage unit 137. The example data storage unit 137 can include one or more tangible computer-readable storage devices. The data storage unit 137 can be a component of the communication system 130 or be logically coupled to the communication system 130. For example, the data storage unit 137 can include on-board flash memory and/or one or more removable memory cards or removable flash memory. In certain example embodiments, the data storage unit 137 may store information, such as telephone numbers, addresses, or other subject 101 information for subjects associated with communication system 130. For example, if the communication system 130 is a 911-dispatch system, the data storage unit 137 may store information related to subjects 101 in the vicinity of the communication system 130 (so that the communication system 130 can direct responders to the subject's location in an emergency).

The precaching system 140 represents a system for precaching responsive information for a recipient 151. As such, the precaching system 140 is configured to communicate with the archival storage system 120, the communication system 130, the precaching system 140, the recipient system 150, the edge storage device 160, and the cloud-based storage system 170 via the network 105. The precaching system 140 can include a web server 141, which may represent the computer-implemented system that the precaching system 140 employs, for example, to receive and process communications from the communication system 130, identify responsive information for a recipient 151, retrieve the responsive information from the archival storage system 120 or the cloud-based storage system 170, and then precache the information for the recipient 151. For example, the precaching system 140 may precache the responsive information on an edge storage device 160 near the recipient 151 or on a server 154 or data storage unit 157 associated with the recipient system 150.

In certain example embodiments, the precaching system may include a web browser 142. The web browser 142, for example, may allow recipients 151 to access the precaching system 140. For example, a recipient may use a user interface of the web browser 142 to select or enter preferences regarding the retrieval and precaching of information, such as how the information—or what information—the recipient is to receive. Additionally or alternatively, a subject 101 may use a user interface of the web browser 142 to set or adjust privacy settings associated with the retrieval and precaching of information pertaining to the subject 101.

The precaching system 140 may further include a data storage unit 147. The example data storage unit 147 can include one or more tangible computer-readable storage devices. The data storage unit 147 can be a component of the precaching system 140 or be logically coupled to the precaching system 140. For example, the data storage unit 147 can include on-board flash memory and/or one or more removable memory cards or removable flash memory or rotating disk or RAM-based cache.

The recipient system 150 represents a system that receives responsive information regarding a subject 101 and provides the responsive information to the recipient 151. As such, the recipient system 150 is configured to communicate with other systems or devices on the network 105, such as the precaching system 140, the communication system 130, and the edge storage device 160. For example, the recipient system 150 may rely on a communication application 153 to receive responsive information via the network 105 or an edge storage device 160 associated with the network 105. The recipient system 150 can also include a web server 154, which may represent the computer-implemented system that the recipient system 150 employs, for example, to process and provide the information from the precaching system 140. The recipient system 150 may also include a workstation terminal 155, for example, which serves as user interface to provide responsive information to a recipient 151. That is, a recipient 151 may view responsive information, for example, at the workstation terminal 155.

The recipient system 150 may further include a data storage unit 157. The example data storage unit 157 can include one or more tangible computer-readable storage devices. The data storage unit 157 can be a component of the precaching system 140 or be logically coupled to the precaching system 140. For example, the data storage unit 157 can include on-board flash memory and/or one or more removable memory cards or removable flash memory or rotating disk or RAM-based cache. In certain example embodiments, the data storage unit 157 may be configured to store precached information received from the precaching system 140 via the network 105 and/or via an edge storage device 160.

In certain example embodiments, the precaching functions of the precaching system 140 may operate and execute completely on other systems and devices associated with the network 105, such as on the archival storage system 120, the communication system 130, the recipient system 150, or the edge storage device 160. Alternatively, the precaching functions of the precaching system 140 may operate and execute separately and independently from the archival storage system 120, the communication system 130, or the edge storage device 160. For example, the precaching system 140 may operate and execute within a separate computing system or other computing system that precaches responsive information as described herein. Alternatively, the precaching functions of the precaching system 140 may execute partially on the archival storage system 120, the communication system 130, the recipient system 150, or the edge storage device 160.

In certain example embodiments, the system architecture may include a five-hierarchical-layer system representing different depths of the network 105 and different tiers of storage performance and cost. The top layer, for example, may include the very high-capacity, archival storage 150 elements where a large majority of data—such as electronic health records—are permanently stored. The cost per byte of the archival storage is perhaps a few percent of the costs of storage in lower layers of the example system described herein. However, the archival storage performance (especially latency) is very slow. For example, retrieving data from the archival storage may take several minutes, which can be far too slow for certain healthcare applications.

The next layer in the example five-hierarchical-layer system includes a cloud layer. The cloud layer may include, for example, storage servers containing multiple, rotating or solid state disk drives and compute servers of a cloud-based network. In certain example embodiments, information may be stored in the cloud on cloud-based storage 170, such as the records for the subject's most recent physician visit. That is, records that have not yet been archived for the subject 101 into the archival storage may reside on the cloud-based storage unit. Large data applications, such as those that allow for distributed processing of large data sets across clusters of computers using simple programming models, may also run on the cloud level. Due to the potential for low latency (0.1 to 10 seconds), such large data applications/storage would be beneficial for large data storage (such as electronic health records). The cost per byte, however, for this type of storage can be cost prohibitive. For example, the cost of large data applications may be up to two orders of magnitude larger than storage in the archival layer. The cloud layer also includes, for example, all the switches, routers, transport gear, and other devices or mediums needed to carry network traffic at high capacities throughout the network 105. The precaching system 140, for example, may also be located in the cloud layer.

In certain example embodiments, the next layer in the example five-hierarchical-layer system is the trigger or “communication” layer. This layer includes, for example, many different types of systems, such as the communication system 130, that are generally the first to know that a request for data, such as electronic health records, is potentially impending. For example, the communication system 130 may include a 911 emergency dispatch system that receives a medical emergency call regarding a particular subject 101. Based on the content of the 911 call, for example, the communication system 130 notifies the precaching system 140 of the received 911 call, and the precaching system 140 determines which electronic health records of the subject 101 are responsive to the communication as described herein. The precaching system 140 then locates the responsive health records of the subject 101 in the layered hierarchy, such as in the archival storage system 120 where they will most likely reside. The precaching system 140 may also fetch pertinent responsive information, if any, from cloud-based storage 170, such as electronic medical records that have not yet been archived in the archival storage system 120.

In certain example embodiments, the next layer in the example five-hierarchical-layer system is the fog-based layer. The fog-based layer may be similar, for example, to a content delivery network or content distribution network, but has specialized storage and processing capabilities that decrease the latency of data delivery. The fog-based layer may run on specific physical boxes or nodes, perhaps located at or near where a recipient 151 will consume the data, such as on an edge storage device 160. Such devices or nodes may include vehicle-mounted devices that are mobile and reside on emergency vehicles like ambulances, fire trucks, or police vehicles. Alternatively, the fog-based, edge storage device 160 may be fixed, such as in hospital emergency rooms, in medical professional offices, or in offices associated with insurance companies or medical researchers, for example.

In certain example embodiments, the functionality of fog-based layer may be integrated with—or execute as part of—applications on an end device (a smartphone or tablet, for example, as described below, which are associated with the recipient 151). For example, the fog functionality may be associated with a physical element, or a logical element that runs as a virtualized process, sharing the resources of some other element. The latency of requests for data located in the fog-base layer could be less than a few seconds, such as less than about 5, 4, 3, 2, or 1, 0.9, 0.8, 0.7, 0.6, 0.5, 0.3 seconds, thus allowing access latency to the precached information to be virtually undetectable by the recipient 151.

The final layer of the example five-hierarchical-layer system includes the endpoint devices, such devices associated with the recipient system 150, that are the interfaces to the recipients 151 of the system. Some of the endpoint devices may include mobile devices, such as smart-connected vehicle systems in an ambulance or handheld smart device. In certain example embodiments, endpoint devices may be network-connected instruments, like imaging scanners, diagnostic instruments, or laboratory apparatuses. Whatever the endpoint device associated with the recipient system, the methods and systems described herein, for example, improve performance, reliability, security, and accessibility associated with providing responsive information. In certain example embodiments, the endpoint device may be associated with a workstation terminal 155, thus allowing a recipient 151 to view and access information from a recipient system 150.

It will be appreciated that the network connections shown are example and other means of establishing a communications link between the computers and devices can be used. Additionally, those having ordinary skill in the art and having the benefit of the present disclosure will appreciate that the archival storage system 120, the communication system 130, the precaching system 140, the recipient system 150, the edge storage device 160, and the cloud-based storage system 170 of FIG. 1 can have any of several other suitable computer system configurations. For example, the recipient system 150 may be embodied as a mobile phone or handheld computer of the recipient 151 and may not include all the components described above.

### Example Processes

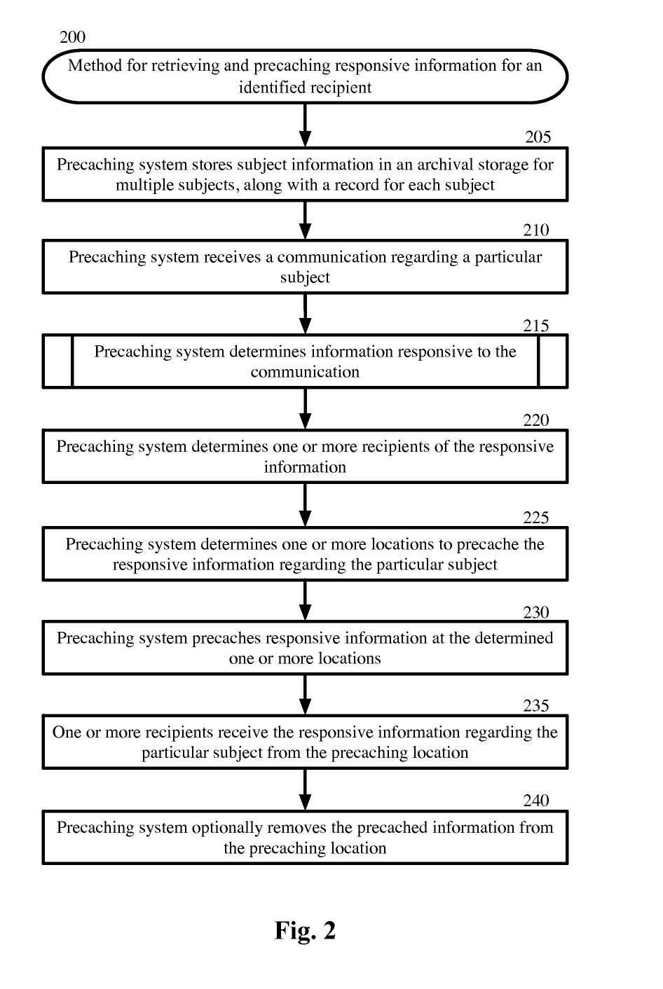

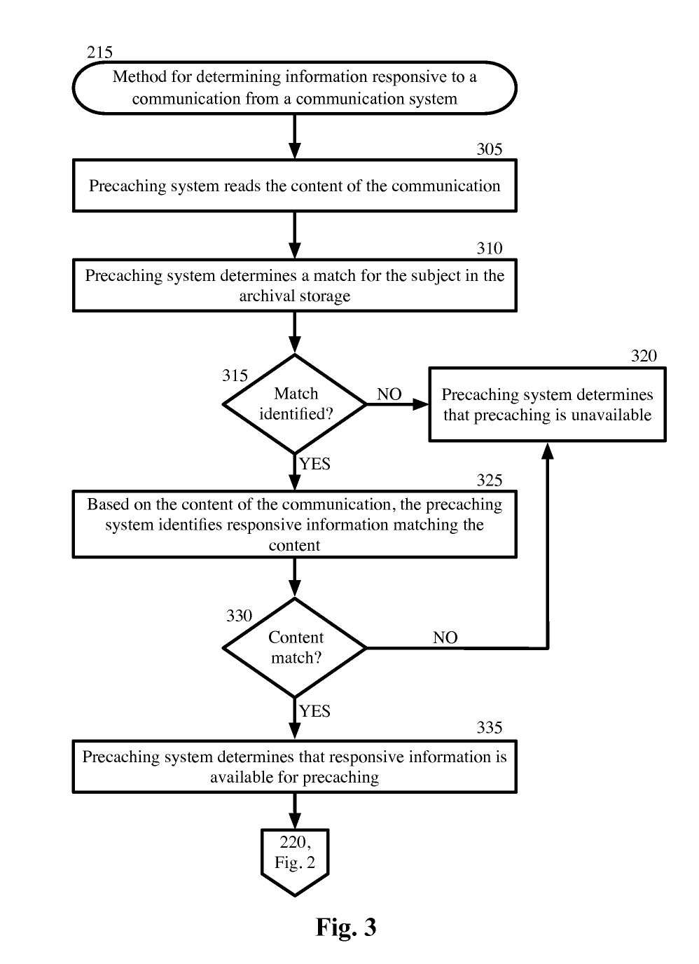

The components of the example operating environment 100 are described hereinafter with reference to the example methods illustrated in FIGS. 2-3.

In certain example embodiments, the methods and systems described herein provide a multilevel, information caching method and system for precaching information for a recipient 151 of the information. For example, the precaching system 140—or another system associated with the network 105—initially pushes large data files, such as electronic health records, to less expensive storage such as an archival storage system 150. Additionally or alternately, certain information may be associated with a cloud-based storage 170, such as health records for a particular subject's most recent physician's visit that have yet to be stored in an archival storage.

Based on the content of received communications of the communication system 130, for example, the precaching system 140 then detects certain trigger events and anticipates that certain information is needed from the archival storage 120 and/or cloud-based storage 170. For example, a healthcare professional may be about to request the health records of the particular subject 101. Based on the anticipated need of the healthcare professional, the precaching system 140 preloads (precaches) the relevant and responsive health records to a faster cache in advance of the need, so that the healthcare professional has the information readily available when needed. For example, the precaching system 140 may preload the information to a web server 141 associated with the precaching system 140, which could then quickly and reliably provide the cached information to the recipient 151 via the network 105.

In certain example embodiments, the precaching system 140 precaches the health records into a more local storage for the recipient 151. For example, the precaching system 140 may precache the electronic health records for a particular subject 101 on an edge storage device 160 physically (geographically) near the recipient 151 and/or on a data storage unit 157 associated with the recipient 150 system, thus allowing a recipient 151 fast access to the health records. For example, the recipient 151 can then view the responsive information, such as on a workstation terminal 155 of the recipient system 150 or on a device (not shown) of the recipient 151. As such, the precaching system leverages the proximity of a storage device near the recipient 151 to increase the speed at which the recipient can access the responsive information. In certain example embodiments, the precaching location may be logically near to the recipient 151, such as on a network having fewer network hops to reach the recipient 151. For electronic health records, the data could be an individual's complete electronic health records, including all physician reports since birth, all lab results, all imaging studies, and genetic sequences. Alternatively, the records may be very specific records regarding the subject 101, such as recent laboratory results for the subject.

Storage devices geographically near the recipient 151, such as the edge storage device 160, may be part of a fog-based architecture of devices deployed near recipients 151. For example, the precaching system 140 may usually store data, such as electronic health records, in large-scale archival storage systems 150 as described herein. But when essential for performance, latency, reliability, or network load reasons, the precaching system 140 fetches the data from the archival storage system 120 and then moves the data temporarily to fog-based computer nodes such as an edge storage device 160. The fog-based nodes may include, for example, specialized network elements or traditional endpoints with the addition of special fog storage control software. The fog-based computer nodes, for example, may be much closer to the anticipated point of use, thus greatly improving the recipient experience through better latency, network load profiles, security, and resiliency.

In certain example embodiments, a recipient 151 may configure the way in which he or she receives the responsive information from the precaching system 140, such as how the recipient 151 receives electronic health records of the subject 101. For example, the recipient 151 (or an operator of the recipient system 150) may access the web browser 142 of the precaching system and select settings for receiving responsive information. A physician, for example, may—by selecting settings associated with the precaching system 140—instruct the precaching system 140 to precache a subset of the records into handheld devices and diagnostic machines used in the physician's office, while precaching other portions of the information on large-screen display devices in an examination room to which the subject 101 has been assigned.

In certain example embodiments, a system operator or recipient 151 may configure the precaching system such that some records (like x-rays) may be visible to the subject 101 and then moved to a larger screen for several individuals to view, whereas other, perhaps more sensitive records—such as psychology reports or private notes—may only be precached on the physician's handheld device for the physician to see and discuss with the subject 101. In certain other example embodiments, a recipient 151 may configure the fetching and precaching of responsive information to occur at convenient times, such as when the storage infrastructure and network are less busy.

In certain example embodiments, the subject 101 may configure the precaching system to include preferred settings of the subject 101. For example, the subject 101 may use a user interface associated with the web browser 142 of the precaching system 140 to identify the subject's preferred physicians, hospitals, dentists, mechanics, or other recipients 151 or recipient systems 150. The subject 101 may also provide identifying information, such as the subject's name, address, telephone number, or other information regarding the subject to the precaching system 140. The precaching system 140 may then store such information in a data storage unit 157 of the precaching system 140. Additionally or alternatively, the precaching system 140 may transmit such information to the archival storage system 120 for association with the subject record 125.

As those skilled in the art will appreciate, anticipating, identifying and retrieving responsive information from an archival storage system 120—and then precaching the responsive information in a more accessible cache for a recipient 151—will have a variety of uses. For example, a subject 101 calls 911, and the emergency dispatch center—acting as a communication system 130—knows the identity of the subject 101 based on the subject's telephone number, calling address, and/or other information typically associated with an emergency dispatch system. The emergency dispatch center communicates the information to the precaching system 140, which then fetches the subject's responsive electronic health records for precaching. The precaching system 140 then precaches the responsive health records of the subject 101 in the fog-based architecture, such as on an edge storage device 160 serving multiple hospitals in the region. The recipients 151 can then view the health record information, for example, on a workstation terminal 155 in the hospital.

Additionally or alternatively, the precaching system 140 may precache the responsive information on a network device associated with the recipient system 150, such on an endpoint device associated with a responding ambulance. For example, the precaching system 140 may precache the responsive information over a cellular data network even as the responding ambulance is in route to a particular location. In certain example embodiments, the precaching system 140 may select vital parts of the subject's health records for precaching on handheld devices of emergency responders, as well as various other intelligent healthcare machines and instruments that may be used in emergency response settings and patient treatment. The precaching system 140 may, in certain example embodiments, prioritize the information to be downloaded into local caches based upon a set of rules designed to insure the most vital or recent information is loaded first. Such precaching of responsive health records could save several minutes (or even hours) of record retrieval time, which could be crucial in emergencies.

In certain example embodiments, a subject 101 schedules an appointment with the subject's physician. Before the subject 101 arrives at the physician's office for the appointment, the appointment scheduling system—acting as the communication system 130—notifies the precaching system 140 of the pending appointment. The precaching system 140 then identifies any responsive electronic health records of the subject 101 from the archival storage system 120. The precaching system 140 then precaches the responsive information for physician (that is, the recipient 151) in advance if the appointment. For example, the precaching system 140 may precache the responsive electronic records on severs associated with the physician's office (such as on a web server 154), on an edge storage device 160 associated with the physician's office, and/or on the web server 141 of the precaching system 140. The physician or other office staff can then view the information on personal devices and/or workstation terminals 155 associated with the physician's office without the delay that would have been experienced had the information been retrieved from archival storage system 120.

In certain example embodiments, a physician may create a consulting referral with another physician, such as a radiologist or other specialist, for the subject 101. A counseling management system—acting as the communication system 130 in this example—communicates the referral to the precaching system 140. The precaching system 140 then identifies the responsive information and precaches the responsive information for a radiologist or other specialist, such as on an edge storage device 160 associated with the radiologist or other specialist. Hence, in certain example embodiments, creating a referral may result in providing the subject's health records to a consulting physician's local system cache for instant retrieval, such as in an emergency. The precaching system 140 may also precache the records to coincide with the radiologist's or other specialist's work schedules. For example, the precaching system 140 may precache records for the radiologist just before the radiologist arrives at work. The radiologist or other office staff can then view the information on personal devices and/or workstation terminals 155 associated with the radiologist's office.

In another example embodiment, a medical laboratory may be processing a blood sample for a subject 101. As the laboratory scans a bar code associated with the subject's blood sample, for example, a laboratory management system—acting as the communication system 130 in this example—notifies the precaching system 140 of the sample testing for the subject 101. The precaching system 140 then fetches the subject's responsive health records and then precaches the records on a server or an edge storage device 160 associated with the laboratory. Additionally or alternatively, the precaching system 140 precaches the responsive information on storage devices associated with other laboratories and specialists that may be involved in treating the subject 101. Hence, by the time the blood tests for the subject 101 are complete, the local recipient systems 130 (and their recipients 131) will have immediate local access to all the past results for trend analysis, anomaly flagging, and/or immediate reporting and processing.

In another example embodiment, an insurance company may be processing a claim for a subject 101. The insurance company, for example, may have a workflow scheduling system for all agents across several regions. As claims are being processed, the workflow scheduling system—acting as the communication system 130 in this example—notifies the precaching system 140 that the subject's electronic health records are needed for processing the claim. The precaching system 140 then retrieves the responsive health records from the archival storage system 120, and then precaches the responsive information into a workstation for the assigned agent (the assigned agent being the recipient in this example). In certain example embodiments, the precaching system may retrieve information from the archival storage system 120 for a task list of the insurance company, and then precache the responsive information for each subject 101 to a workstation for each assigned agent. The individual agents will thus not have to wait to retrieve responsive information in the electronic health records stored in the archival storage system 120. The agents can then view the information on personal devices and/or workstation terminals 155 associated with the workstations.

In another example embodiment, a medical research team, for example, may be conducting a study, such as a genetics study. As part of the study, the research team may rely on a large archival storage system 120 that includes information regarding thousands of subjects 101 for the study. For example, the record for each subject 101 in the archival storage system 120 may be associated with codes or other reference information related to certain criteria for the study. Based on information from the researchers, a workflow scheduling system may generate a batch process of information to be retrieved from the archival storage system 120. The workflow scheduling system—acting as the communication system 130—thus communicates the batch request to the precaching system 140, which then fetches the responsive information from the archival storage system 120. The precaching system 140 then precaches the responsive information on a system associated with the research team, such as on an edge storage device 160 near the research team. In certain example embodiments, the researchers may configure the precaching system 140 to fetch and precache the information at convenient or lightly loaded times as described herein. Hence, the precaching system 140 may retrieve huge genetic data sets from the large offline archival storage system 120, and then preload the data onto the researcher's local workstations and processors for analysis at a later time.

In another example embodiment, a dental patient (a subject 101) always schedules a cleaning and examination appointment every six months, such as in early January and early July, with a particular dentist. A special plugin for the subject's calendar application, such as on a device (not shown) belonging to the subject 101, analyzes past requests and discovers the six-month pattern. Additionally or alternatively, the subject enters the appointment information directly into an application on the device of the subject 101, and the device reads the appointment time and date. The application—acting as the communication system 130 in this example—notifies the precaching system 140 of the pattern or the upcoming time and date and the need for responsive dental information for the subject at the repeating or appointed times. At or near the time of the anticipated appointment for the subject, for example, the precaching system 140 preloads the subject's dental records from the archival storage system 120 to the particular dentist's local servers in anticipation of the subsequent appointments. Such precaching allows the dentist's office servers to hold full copies of subject's data for a few weeks per year (rather than year around). Hence, the responsive information is relegated to the archival storage system 120 for most of the year, which saves on local storage array costs.

While certain of the above example embodiments relate to electronic heath medical record of a subject, in other example embodiments the retrieved records may be records of any type. For example, a subject 101 may schedule an appointment with a mechanic to have the subject's automobile serviced. Alternately, if the vehicle associated with subject 101 is a smart connected vehicle, its internal diagnostics systems may detect the need for service at any time, and send network messages to trigger a precaching request without human involvement, in anticipation of a service visit. A scheduling system associated with the mechanic—acting as the communication system 130 in this example—notifies the precaching system 140 of the pending appointment. Then, before the appointment, the precaching system 140 retrieves the subject's automobile service records from the archival storage system 120. The precaching system 140 then precaches the service records on a workstation of the mechanic, thus allowing the mechanic (that is, the recipient 151) to access the automobile's entire service record. For example, the mechanic may view the service records on a personal device and/or workstation terminal 155 associated with the mechanic.

Additionally or alternatively, an on-board vehicle monitoring system with communication ability may detect a crash associated with the subject's vehicle. The on-board vehicle monitoring system—acting as the communication system 130 in this example—may communicate information regarding the crash directly or indirectly to the precaching system 140. The precaching system 140 can then retrieve and precache responsive information to a system associated with the subject's mechanic as described herein. The precaching system 140 may also precache responsive health records for the subject 101 at nearby hospitals.

The example embodiments provided herein quickly, efficiently, and reliably provide the responsive information, such as responsive health records, to the recipients 131 (as compared to accessing the responsive information directly from the archival storage system 120, for example). Healthcare professionals, first responders, medical researches, insurance agents, and many other recipients 131, for example, can use the methods and systems described herein, for example, connect to the storage hierarchy and retrieve data (such as health records or other information). Such recipients 131 can also use devices associated with the recipient system 130 enhance response time and job performance.

FIG. 2 is a block flow diagram depicting a method 200 for retrieving and precaching responsive information for an identified recipient 151, in accordance with certain example embodiments.

With reference to FIGS. 1 and 2, in block 205, the precaching system 140 stores subject information in an archival storage for multiple subjects 101, along with a record for each subject 101. For example, when the precaching system 140 first receives information relating to a particular subject 101, the precaching system 140 stores the information in an archival storage system 120, along with information regarding the subject 101, such as the subject's name, address, date of birth, or other identifying subject information or credentials. As the precaching system 140 receives additional information regarding the subject 101, for example, the precaching system 140 can then associate (store) the information with the subject record 125 of the archival system 120. The precaching system 140 can also use subject record 120 to later retrieve responsive subject information, such as when the precaching system 140 determines that the archived subject information is responsive to a communication regarding the subject 101 as described herein.

In certain examples, another system, such as a separate system that may be affiliated with the precaching system 140, may perform the storage functions of the precaching system as described herein. For example, a hospital may transmit electronic health records of a subject directly to the archival system 120 for storage. The precaching system 140 can then access the archival storage system 120 to retrieve response information regarding the subject 101 as described herein.

In certain example embodiments, certain information may be associated with a cloud-based storage system 170. For example, recently generated electronic health records of a subject that have not yet been archived may be stored on the cloud-based storage system 170. Thus, in certain example embodiments, the precaching system 140 may identify responsive information stored in the cloud-based storage and then precache the responsive information in the fog-layer, such as on an edge storage device, as described herein. The type of archived information can also be any information that relates to one or more subjects 101. For example, the information may comprise electronic health records of various subjects, maintenance records for items belonging to various subject (such as automobile maintenance records), insurance records, or any other type of records kept by or on behalf a subject 101.

With regard to electronic health records, the information may include a range of data, including demographics, medical history, medication and allergies, immunization status, laboratory test results, radiology images, vital signs, dental records, personal statistics like age and weight, health billing information, or any other health-related information of one or more subjects 101. For example, such information includes information that may be generated within an institution, such as a hospital, or an integrated delivery network, clinic, or a physician's office or dentist's office. When the archived information concerns private information of the subject 101, such as private health records of the subject 101, the subject 101 may authorize the precaching system 140 or other system to archive the subject's electronic health records in accordance with accepted policies and practices associated with the receipt and storage of health and medical information. In certain example embodiments, the precaching system 140 may be configured to recognize and implement the policies and practices for handling private information. Hence, in such example embodiments, the precaching system may insure that only the appropriate subset of data stored within the system are made available to the various recipients 151 in accordance with their individual authorizations to view such data.

In block 210, the precaching system 140 receives a communication regarding a particular subject 101. That is, a communication system 130 communicates information regarding the subject 101 to the precaching system 140, such as via the network 105. For example, the communication system 130 may detect or receive a communication regarding a subject, which acts as a trigger to initiate the methods and systems described herein. The communication system 130 then transmits the informational content of the communication to the precaching system 140 via the network 105. The content may signify, for example, the occurrence of an event regarding the subject 101, such as a medical emergency of the subject 101 or that the subject has a scheduled appointment. The precaching system 140 then receives the information via the network 105, thus commencing the precaching of responsive information according to the methods described herein.

The communication system 130 can include any system or source that receives and processes communications regarding a subject 101. In certain example embodiments, the communication system 130 may include an emergency dispatch system, such as a 911 emergency dispatch system, that receives, processes, and manages calls for police, fire, and medical emergencies. Additionally or alternatively, the communication system 130 may include a laboratory management system, such as a system that monitors, processes, and manages clinical and/or research laboratory appointments. Additionally or alternatively, the communication system 130 may include a hospital-based computing system that receives, processes, and manages hospital calls, patient information, and patient admittance.

Additionally or alternatively, the communication system 130 may include an appointment scheduling system, such a system that schedules and manages appointments for professional services. For example, the scheduling system may monitor patient appointments for physicians, dentists, orthodontists, veterinarians, or other medical professionals or their medical staff. Additionally or alternatively, the appointment scheduling system may monitor, schedule, and/or process appointments for non-medical professionals, such as medical or non-medical insurance providers, mechanics, or any other non-medical service provider. Additionally or alternatively, the communication system 130 may include a workflow scheduling system, such as a system responsible for identifying, retrieving, and/or processing information related to a particular work-related task or objective.

Additionally or alternatively, the communication system 130 may include—or be associated with—a calendar application. For example, a calendar application on a device (not shown) of a subject may be communicate with the communication system 130 and/or the precaching system 140. Based on calendar entries of the subject, the communication system 130 can then determine upcoming appointments for the subject 101, such as an appointment to see a physician or an appointment for servicing the subject's automobile are to occur in the future. The calendar application may also identify recurring appointments for the subject.

The information that the communication system 130 communicates to the precaching system 140 may include, for example, the subject's name, address, or other identifying information or credentials, such as a unique identification number belonging to the subject 101. The communicated information may also include an indication of the nature of the communication, such as a description regarding the communication's content. For example, the information may generally indicate that an emergency dispatch service dispatched an ambulance to the subject's residence for a health emergency regarding the subject 101. Alternatively, the information may indicate a scheduled vehicle maintenance appointment with the subject's mechanic. As such, the communication indicates the type of information that may be responsive to the communication. For example, if the nature of the communication involves an emergency dispatch to the subject's residence, the precaching system 140 determines, as described in more detail below, that electronic health records of the subject 101 may be responsive to the communication as described herein.

In certain example embodiments, the communicated information from the communication system 130 may be highly detailed. For example, the information may indicate that an ambulance was dispatched to the subject's residence for a cardiac event associated with the subject 101. The communicated information may also provide an indication of one or more recipients 151. For example, information regarding a medical emergency of the subject 101 may serve as an indication that local hospitals are likely to need the subject's electronic health records and that one or more of the hospitals are the recipients.

In block 215, the precaching system 140 determines information responsive to the communication based on the content of the received communication. For example, the precaching system reads the communication received from the monitoring system 150 to determine the content of the communication. Based on the content of the communication for example, the precaching system 140 identifies the subject associated with the communication, as well as a recipient of information that is responsive to communication. The precaching system 140 then relies on the determined identity of the subject 101 to locate a record for the subject 101 in the archival storage. The precaching system 140 then identifies responsive information from the archived information associated with the record of the subject 101 in the archival storage. The details of block 210 are described in further detail below with reference to FIG. 3.

FIG. 3 is a block flow diagram depicting a method 215 for determining information responsive to a communication from a communication system 130, in accordance with certain example embodiments.

With reference to FIGS. 1 and 2, in block 305 of method 215, after the precaching system 140 receives the communication from the communication system 130, the precaching system 140 reads the content of the communication. That is, the precaching system 140 analyzes the communication to determine the content of the information contained in the communication. For example, the precaching system 140 may determine the name, address, telephone number, identification number, or other identifying information or credentials for the subject 101 based on the content of the communication. The precaching system 140 may also determine the nature of the communication, such as what the communication pertains to or concerns, and what trigger events initiated this request.

Based on the content of the communication, the precaching system 140 determines an indication of the information that may be responsive to the communication. For example, if the content of the communication indicates that an ambulance was dispatched to a subject's residence, then the precaching system 140 may determine that the communication concerns a medical emergency of the subject 101. Hence, the precaching system 140 may determine that the subject's electronic health records are likely responsive to the communication as described herein.

In block 310, the precaching system 140 determines a match for the subject in the archival storage system 120. That is, based on the identifying information of the subject 101 that the precaching system 140 determines from the content of the communication, the precaching system 140 determines if a record for the subject 101 exists in the archival system 120, such as in the subject record 125 for multiple subjects. For example, the precaching system 140 may compare the name of the subject 101—or the unique identification number of the subject 101—with the names and/or identification numbers of subjects in the in the subject record 125. If the precaching system 140 identifies a matching name and/or identification number for the subject in the subject record 125, for example, the precaching system 140 determines that a match exists for the subject 101 in the subject record 125 of the archival storage system 125. But if the precaching system 140 does not find a match for the subject's information in the subject record 125, then the precaching system 140 determines that a subject match does not exist.

In certain example embodiments, the precaching system 140 may additionally or alternatively determine if a record for the subject exists in a cloud-based storage. That is, if a recipient 151 and/or a subject 101, for example, has configured the precaching system 140 to retrieve data from certain cloud-based storage units 170, such as those that may be affiliated with the recipient and/or the subject 101, the precaching system 140 may search the cloud-based storage units 170 for a record associated with the subject 101. For example, a hospital at one location in a city may configure the precaching system 140 to search for records of the subject 101 on cloud-based storage units at nearby hospitals (in addition to searching subject record 125 of the archival storage system 120). By searching the cloud-based storage system 170, the precaching system 140 may, for example, identify a record for the subject 101 that is associated with information that the precaching system 140 (or another system) has yet to store in the archival storage system 120.

If the precaching system 140 determines that a match does not exist for the subject 101, the method follows the “NO” branch of block 315 to block 320 of FIG. 3. But if the precaching system 140 determines that a match does exist for the subject 101 in the subject record 125 of the archival storage system 125 and/or the cloud-based storage system 170, then the method follows the “YES” branch of block 315 to block 325 of FIG. 3, in accordance with certain example embodiments.

In block 320, if the precaching system 140 determines that a match does not exist for the subject 101, the precaching system 140 determines that precaching of archived information is unavailable for the subject 101. That is, because a record does not exist for the subject 101 in the archival storage system 120 or any cloud-based storage system 170, for example, the precaching system 140 does not identify any records for precaching. The method thus terminates.

In block 325, after the precaching system 140 determines a match for the subject 101, the precaching system 140 identifies—based on the content of the communication—responsive information matching the content. That is, the precaching system 140 attempts to locate information—in an archival storage system 120 and/or a cloud-based storage system 170—that corresponds to the content of the communication. For example, if based on the content of the communication the precaching system 140 determines that the communication relates to a medical emergency of the subject 101, the precaching system 140 attempts to identify electronic health records of the subject 101 from the archival storage system 120 (and/or from a cloud-based storage system 170, for example). Similarly, if the content of the communication indicates that the subject 101 has an appointment to service the subject's vehicle, the precaching system 140 attempts to identify information regarding the service records for the subject's vehicle. Likewise, if the precaching system 140 determines—based on the content of the communication—that the subject 101 has an upcoming dental appointment, for example, the precaching system 140 attempts to identify dental records for the subject 101.

If the precaching system 140 does not identify content in the archival storage system 120 and/or a cloud-based storage system 170 that matches the determined content from the received communication, the method follows the “NO” branch of block 330 to bock 320 of FIG. 3. That is, because the precaching system 140 determines that information matching the content of the communication is unavailable, the precaching system 140 determines that responsive information is also unavailable and that hence precaching of responsive information is unavailable. The method thus terminates. If, however, the precaching system 140 identifies content in the archival storage system 120 and/or a cloud-based storage system 170 that matches the determined content from the received communication, the method follows the “YES” branch of block 330 to block 335, in accordance with certain example embodiments.

In block 335, once the precaching system 140 identifies content matching the content of the received communication, the precaching system 140 determines that responsive information is available for precaching. That is, the precaching system 140 determines that the identified content is responsive to the communication and hence available to precache for a recipient 151. For example, if in response to a communication concerning a medical emergency of a subject the precaching system 140 identifies electronic health records of the subject 101, the precaching system 140 determines that the electronic health records are available for precaching. Likewise, if the precaching system 140 identifies vehicle service records for a subject 101 in anticipation of a service appointment for subject's vehicle, the precaching system 140 that responsive information—that is, the vehicle service records—are available for precaching.

Returning to FIG. 2, in block 220 of FIG. 2, the precaching system 140 determines a recipient 151 of the responsive information. That is, based on the content of the communication and/or the identified information, the precaching system 140 identifies one or more entities that should receive the responsive information. For example, if the precaching system 140 determines that the communication received from the communication system 130 relates to a medical emergency of the subject 101—and electronic health records of the subject 101 are available for precaching—the precaching system 140 may determine that the medical staff a one or more local hospitals should be the recipients 151. In other words, the precaching system 140 identifies—as a recipient—one or more entities that would find the information useful.

Alternatively, if the precaching system 140 determines that the communication and/or identified responsive information relates to a service appointment of the subject's vehicle, then the precaching system 140 determines that the subject's mechanic is the recipient 151. For example, the precaching system 140 may receive a communication, such as from a scheduling application associated with a device (not shown) of the subject. Based on the content of the communication, the precaching system 140 determines that service records for the subject's vehicle are responsive information and that a mechanic is a likely recipient of the service records. The precaching system may also determine—from the content of the responsive information—the name of a particular mechanic recipient of the responsive information. For example, the precaching system 140 may identify a particular mechanic in the archived service records of the subject 101. In certain other example embodiments, the precaching system 140 may identify the recipient based on subject-configured settings of the precaching system 140. For example, the subject 101 may, when configuring the precaching system, identify a particular mechanic, dentist, physician, insurer, or other professionals as recipients of responsive information.

In certain example embodiments, the precaching system 140 may identify multiple recipients 151. For example, if the precaching system 140 receives a communication that a subject 101 has been in a car crash—and then identifies responsive information relating the subject's electronic health records, automobile insurance records, and vehicle service records—the precaching system 140 may identify different recipients 151 for the responsive information. For instance, the precaching system 140 may identify medical staff at one or more local hospitals—and any associated medical response teams, such as ambulances—as recipients of the electronic health records. The precaching system 140 may likewise identify the subject's automobile insurer and mechanic, respectively, as recipients 151 of the subject's insurance information and vehicle service records.

In block 225, the precaching system 140 determines one or more locations to precache the responsive information regarding the particular subject 101. That is, the precaching system 140 determines one or more physical locations to store the responsive information so that the recipients 151 can more readily access the responsive information, thus decreasing the latency associated with the recipients 151 receiving the information. If the responsive information was originally stored in an archival storage system 120—such as an offline, robot tape archive or optical jukebox—the determined location may be any location within the cloud (online) network 105. For example, the location may be a cloud-based storage system 170, the web server 141 of the precaching system 140, or any other web server connected to the network 105. Such cloud-based, online locations, for example, allow the recipients 151 to more quickly access the information (as compared to accessing the same information directly from the archival storage system 120 as described herein).

In certain example embodiments, the precaching location may also be a specific, geographic location, such as a location “near” the recipient 151 in the network 105. Being near the recipient 151, for example, such locations may provide quick access to the responsive information as compared to locations that are more distant from the recipient 151. For example, a recipient located in New York may more quickly access the responsive information from a cloud-based storage system 170 in New York thank a cloud-based storage system 170 in California. In certain example embodiments, a location near a recipient 151 may be a configurable distance from a recipient 151, such as within a configurable radius around the recipient 150. For example, the precaching location may be within a radius of 1, 2, 3, 4, 5, 6, 7, 8, 9, 10, 15, 20, 25, 30, 40, 50, 100, 200, 300, 400, 500, 700, or 1,000 kilometers from a recipient. Additionally or alternatively, the location may be in the same region of a recipient, such as in the same town, city, county, state, or province of the recipient 151.

Additionally or alternatively, a location “near” the recipient may be based on the number of network hops or “hop counts” to reach the recipient system 150 or a device of the recipient 151. That is, a network transmission path from the precaching location to the recipient system 150 may be logically “nearer” to the recipient system 150 if there are fewer devices, such as routers or servers, through which the transmission of responsive information must occur. For example, a location that requires only 10 hops to reach the recipient system 150, rather than 15 hops, would be nearer to the recipient 151, for example. Similarly, a location “near” the recipient may be based upon network bandwidth available between the location and the recipient. For example, a location connected to the recipient 151 via high-speed fiber optical networking facilities may be preferable to one that is geographically closer to the subject but that is connected with lower speed DSL networking facilities.

In certain example embodiments, the location may be within a fog layer of the network 105 as described herein, such as on an edge storage device 160 located near one or more recipients 151. For example, the edge storage device 160 may be located on emergency vehicles, such as on ambulances, fire trucks, or other mobile emergency response vehicles. Additionally or alternatively, the edge storage device 160 may be located at or near hospital emergency rooms, in medical professional offices, or in offices associated with insurance companies or medical researchers, for example. Additionally or alternatively, the location may be a server at or near the recipient, such as on a web server 154 on the recipient system 150. For example, when medical professional at a hospital are the recipients 151 of the responsive information, the location may be a web server 154 located at or near the hospital. Additionally or alternatively, the precaching system 140 may determine locations associated with endpoint devices of the recipients 151. For example, the precaching location may be a mobile phone of a recipient 151, such as a mobile phone of a first responder. By determining one or more locations near the recipients 151, the precaching system 140 decreases the latency associated with the recipients 151 accessing the information (as compared to accessing the information from an archival storage system 120 and/or a more distant location from the recipients 151).

In certain example embodiments, the precaching system 140 may determine multiple precaching locations, such as locations corresponding to different recipients 151. For example, if the communication indicates that the subject 101 was involved in a car crash—and the precaching system 140 identifies responsive health records, insurance information, and vehicle service records—the precaching system 140 identify local hospitals, the subject's automobile insurer, and the subject's mechanic as the recipients 151, respectively. Hence, the precaching system 140 may determine locations at or near the local hospitals, the subject's automobile insurer, and the subject's mechanic as precaching locations. In certain example embodiments, the precaching system 140 may determine—for the identified responsive information—multiple locations within the five-layer hierarchal system described herein. For example, the precaching system 140 may determine precaching locations at the cloud layer, the fog layer and/or the endpoint layer.

Additionally or alternatively, the precaching location may be determined based on reliability of the network 105 at or near the location. That is, in certain example embodiments, the precaching system 140 may identify a location that is more reliable than another location, so as to increase the likelihood that the one or more recipients 151 receive the information (from the more reliable location). In certain example embodiments, the location may be associated with a private network, such as a virtual private network (“VPN”), so that private information—such as private information regarding the subject 101—is not publically accessible.

In block 230, the precaching system 140 precaches the responsive information at the determined one or more locations. That is, the precaching system 140 communicates the responsive information, via the network 105, to the one or more determined locations—such as to an edge storage device 160 or other device or system at the location—to store (precache) the responsive information. As such, the responsive information becomes available to the one or more recipients 151 at the locations. In certain example embodiments, the precaching system 140 may copy the responsive information from the archival storage system 120 and/or the cloud-based storage system 170, and then transmit the copied information via the network 105 to the determined one or more precaching locations for storage. Alternatively, the precaching system 140 may remove the information from the archival storage system 120 and/or the could-based storage system 170, and then transfer the responsive information via the network 105 to the determined one or more precaching locations.

In certain example embodiments, the responsive information can be loaded into precaches according to a priority list. For example, the precaching system 140 may load the most important or most recent data elements first, and then load lower priority or older records later in the process, as needed. For example, the precaching system 140 may load electronic health records from the most recent record to the oldest record. In a medical emergency, the precaching system 140 may first load a list of the subject's current medications so that the emergency responders can immediately monitor drug interactions upon arriving at the scene of the emergency. The precaching system 140 may subsequently load lower priority items, such as records for the subject's most recent doctor's visit. In certain example embodiments, the precaching system 140 may rely on configurable algorithms to determine precaching priority based upon the specific areas of interest of a particular recipient 151.

In block 235, a recipient 151 accesses the responsive information regarding the particular subject 101 from the precaching location (or locations). That is, the recipient 151 can receive the responsive information from the precaching location. For example, if the precaching system 140 precaches the information on an edge storage device 160 near a recipient 151, the recipient 151 can access the information via the recipient system 150 associated with the edge storage device 160. The recipient 151 may view the responsive information, for example, on a user interface (not shown) of a workstation terminal 155 associated with the recipient system 150. Additionally or alternatively, the recipient 151 may use a web browser associated with a device (not shown) of the subject 101 to view the responsive information. For example, the subject 101 may view the responsive information on a mobile telephone of the subject 101. Advantageously, the perceived speed of network 100 is much faster when precaching system is able to retrieve information from the fast, more local storage of precaching system 140 or edge storage device 160 than it would be if recipient 151 or recipient system 150 retrieved the information from archival storage system 120 or cloud-based storage system 170. Also, the impacts of network load, or failures of many of the elements in network 100, or certain security hazards can be largely mitigated via the use of precaching.

In block 240, the precaching system optionally removes the precached information from the precaching location. For example, a recipient 151 and/or operator of the recipient system 150 may configure the precaching system such that—once one or more recipients 151 access the responsive information from the precaching location—the precaching system 140 removes the ability to access the information from the precaching location. Removing the precached information, after each of the recipients 151 accesses the information, may free up storage space at the precaching location such that additional information can be precached at the location.

For example, if the precaching system 140 has previously copied the responsive information from an archival storage system 120, the precaching system 140 may be configured to delete the responsive information from the precaching location after one or more recipients 151 access the information. Alternatively, if the precaching system 140 has previously removed the responsive information from an archival storage system 120—instead of copying the information from the archival storage system 120—the precaching system 140 may be configured to return the responsive information to the archival storage system 120 once the one or more recipients 151 access the responsive information. In certain example embodiments, the subject 101 may also configure the precaching system 140 as described herein to remove the responsive information from the precaching location.

In certain example embodiments, when the recipient 151 accesses the responsive information, such by viewing the responsive information on a workstation terminal 155 of the recipient system 150, the precaching system 140 may be configured to provide the recipient 151 with a user control button that allows the recipient 151 to manage accessibility to the responsive information. For example, the precaching system 140 may provide, on a user interface (not shown) of the workstation terminal 155 “delete now” or “return to storage” button. By selecting the button, such as by “tapping” or “clicking” on the button, a recipient 151 can indicate a desire to remove or limit access to the precached information.

Additionally or alternatively, a recipient 151, an operator (not shown) of the recipient system 150, and/or the subject 101 may configure the precaching system 140 to make the precached information available for a limited amount of time. For example, the recipient 151 may configure the precaching system 140 so that the responsive information is available from the precaching location for a specific number of hours, such as about 1, 2, 3, 4, 5, 6, 7, 8, 9, 10, 11, or 12 hours. The recipient 151 may similarly configure the precaching system so that the responsive information is available from the precaching location for a specific number days or weeks, such as 1, 2, 3, 4, 5, 6, or 7 days or 1, 2, 3, 4, 5, 6, 7, 8, 9, 10, 11, or 12 weeks. Additionally or alternately, various release trigger events, such as discharge from a hospital, generation of a bill, finalization of a lab report, or return of vehicle keys to the subject 101 may prompt the precaching system 140 to remove the ability of the subject to access the precached information as described herein. For example, the precaching system 140 may receive an input of, detect, or otherwise read a storage release trigger event and initiate a function to delete the information from the precache location, thus freeing precache space for future precache requests.

### Other Example Embodiments

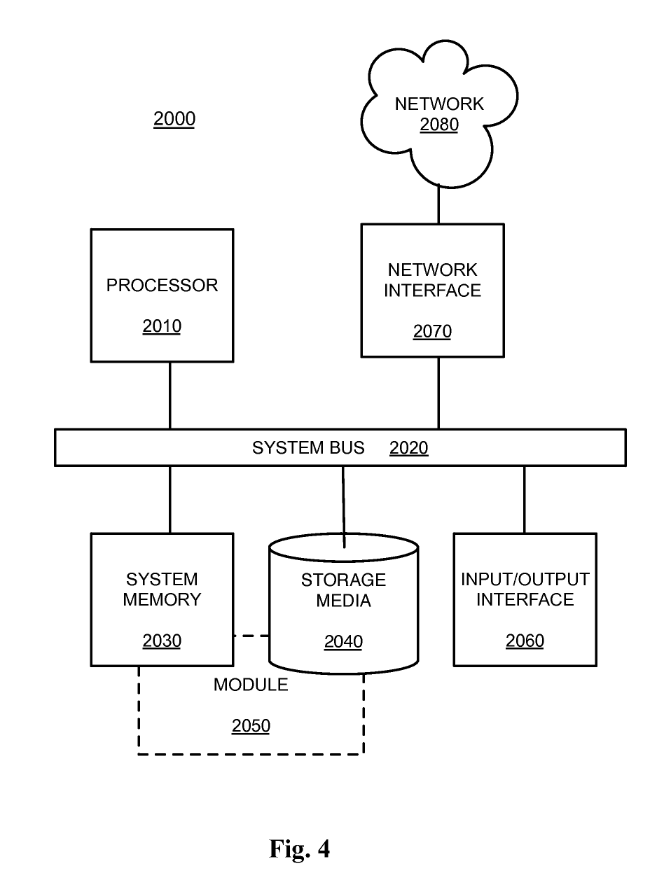

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, instruments, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, instruments, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about subjects, or may make use of personal information, the subjects may be provided with an opportunity or option to control whether programs or features collect subject information (e.g., information about a subject's social network, social actions or activities, profession, a subject's preferences, or a subject's current location), or to control whether and/or how to receive content from the content server that may be more relevant to the subject. In addition, certain data may be treated in one or more ways before it is stored or used, so that personally identifiable information is removed. For example, a subject's identity may be treated so that no personally identifiable information can be determined for the subject, or a subject's geographic location may be generalized where location information is obtained (such as to a city, ZIP code, or state level), so that a particular location of a subject cannot be determined. Thus, the subject may have control over how information is collected about the subject and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. The media may be located in proximity to system 2000, in the Fog layer, or in the Cloud. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the examples described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A method, comprising:
receiving, by one or more computing devices, a communication regarding a subject, wherein the communication comprises content indicating information that is responsive to the communication;
determining, by the one or more computing devices and based on the content of the communication, information that is responsive to the communication, wherein the responsive information is associated with an archival storage system;
determining, by the one or more computing devices, a recipient of the responsive information;
determining, by the one or more computing devices, a location to precache the responsive information, wherein the location is associated with a non-archival network and is based on the recipient; and
in response to determining a location to precache the information, precaching, by the one or more computing devices, the responsive information at the determined precaching location.

2. The method of claim 1, wherein determining information that is responsive to the communication comprises:
reading, by the one or more computing devices, the content of the communication, wherein the content of the communication provides the indication of responsive information and an identity of the subject;
determining, by the one or more computing devices, a match for the subject in a record associated with the archival storage system;
determining, by the one or more computing devices, information associated with the record for the subject that matches the indication of responsive information; and
in response to determining information associated with the record for the subject that matches the indication of responsive information, determining that information responsive to the communication is available for precaching.

3. The method of claim 1, wherein determining a recipient of the responsive information comprises identifying, by the one or more computing devices and based on the content the communication, one or more entities to receive the responsive information.

4. The method of claim 1, wherein determining a location for precaching the responsive information comprises determining, by the one or more computing devices, a physical location to precache the responsive information that is logically or geographically near the recipient or a combination thereof.

5. The method of claim 4, wherein the information is precached on an edge storage device near the recipient, a vehicle-mounted device, an end point device of the recipient, or a combination thereof.

6. The method of claim 1, wherein determining information that is responsive to the communication further comprises:
determining, by the one or more computing devices, responsive information that is associated with a cloud-based storage system; and
precaching, by the one or more computing devices, the responsive information associated with the cloud-based storage system at the determined precaching location.

7. The method of claim 1, further comprising removing, by the one or more computing devices, the precached information from the precaching location in response to determining that a trigger event has occurred indicating that the precached information can be removed from the precaching location.

8. The method of claim 7, wherein the trigger event comprises at least one of expiration of a timer, discharge from a hospital, generation of a bill, finalization of a lab report, completion of a research project, and return of vehicle keys to a customer.

9. The method of claim 1, wherein precaching the information at the determined precaching location results in a decreased latency associated with the recipient receiving the information compared to retrieval by the recipient directly from the archival storage system.

10. The method of claim 1, wherein precaching the information at the determined precaching location results in an increased security or reliability associated with accessing the precached information.

11. The method of claim 1, wherein the communication is received from an emergency dispatch center, an appointment scheduling system, a laboratory management system, a workflow scheduling system, a calendar application, or a combination thereof.

12. A tangible, non transitory, computer readable media having software encoded thereon, the software when executed by a processor operable to:
receive a communication regarding a subject;
determine a content of the communication, wherein the content of the communication comprises an indication of information that is responsive to the communication and an identity of the subject;
identify, based on the indication of information that is responsive to the communication and the identity of the subject, information that is responsive to the communication, wherein the responsive information is associated with an archival storage system;
determine, based on the content of the communication, a recipient of the responsive information;
determine a location for precaching the responsive information, wherein the location is associated with a non-archival storage system; and,
in response to determining a location for precaching the information, precache the responsive information at the determined precaching location.

13. The tangible, non transitory, computer readable media of claim 12, wherein determining information that is responsive to the communication comprises:
determining a match for the subject in a record associated with the archival storage system;
determining information associated with the record for the subject that matches the indication of responsive information; and,
in response to determining information associated with the record for the subject that matches the indication of responsive information, determining that information responsive to the communication is available for precaching.

14. The tangible, non transitory, computer readable media of claim 12, wherein the precaching location is a physical location near the recipient.

15. The tangible, non transitory, computer readable media of claim 14, wherein the precaching location comprises an edge storage device near the recipient, an end point device of the recipient, a vehicle-mounted device, or a combination thereof.

16. The tangible, non transitory, computer readable media of claim 12, wherein identifying information that is responsive to the communication further comprises identifying responsive information that is associated with a cloud-based storage system.

17. The tangible, non transitory, computer readable media of claim 16, further comprising precaching the responsive information associated with the cloud-based storage system at the determined precaching location.

18. An apparatus, comprising:
a processor adapted to execute one or more processes; and
a memory configured to store a process executable by the processor, the process when executed operable to:
receive a communication regarding a subject,
determine a content of the communication, wherein the content of the communication comprises an indication of information that is responsive to the communication;
determine, based on the content of the communication, information that is responsive to the communication, wherein the responsive information is associated with an archival storage system;
determine a recipient of the responsive information;
determine a location for precaching the responsive information, wherein the location is associated with a cloud-based network; and,
in response to determining a location for precaching the information, precache the responsive information at the determined precaching location.

19. The apparatus of claim 18, wherein, when determining information that is responsive to the communication, the process when executed is further operable to:
read the content of the communication to determine an identity of the subject;
determine a match for the subject in a record associated with the archival storage system;
determine information associated with the record for the subject that matches the indication of responsive information; and,
in response to determining information associated with the record for the subject that matches the indication of responsive information, determine that information responsive to the communication is available for precaching.

20. The apparatus of claim 18, wherein the precaching location comprises an edge storage device near the recipient, a vehicle-mounted device, an end point device of the recipient, or a combination thereof.
